(19) United States
(12) Patent Application Publication
(10) Pub. No.: US 2024/0062746 A1
(43) Pub. Date: Feb. 22, 2024

(54) SYSTEMS AND METHODS FOR REDACTION OF SENSITIVE INFORMATION FROM VOICE COMMUNICATIONS

(71) Applicant: Red Box Recorders Limited, Bradmore (GB)

(72) Inventors: Pete ELLIS, Bradmore (GB); Simon JOLLY, Bradmore (GB)

(21) Appl. No.: 18/234,787

(22) Filed: Aug. 16, 2023

Related U.S. Application Data
(60) Provisional application No. 63/399,160, filed on Aug. 18, 2022.

(51) Int. Cl. G10L 15/08; G10L 25/48; G06F 21/60

(52) U.S. Cl. CPC G10L 15/08; G10L 25/48; G06F 21/60

(57) ABSTRACT

The redaction system and methods use primary triggers and secondary triggers to initiate redaction capabilities. A primary trigger is initiated when sensitive data is first detected and acts forward in time from the detection event. A secondary trigger is initiated at the end or during the timing of the first trigger and acts both backwards and forwards in time from its initiation. Combining the detection results from these two triggers allows confidence that all sensitive data is removed while avoiding false positives.

### CROSS-REFERENCE TO RELATED APPLICATIONS

This application claims priority to U.S. Provisional Application Ser. No. 63/399,160, filed Aug. 18, 2022, the entire content of which is hereby incorporated by reference in its entirety.

### FIELD OF THE INVENTION

This disclosure generally relates to systems and methods for redacting personally identifiable or sensitive information from real-time or recorded voice communications, including associated call metadata and transcripts.

### BACKGROUND

In order for voice communications to be stored for long term archiving, it is often a requirement that sensitive information, such as credit card numbers or personal information, needs to be removed from the voice communications to ensure that privacy is maintained, especially to comply with privacy laws and financial regulations. It would be too burdensome to remove the sensitive information manually from hundreds or thousands of different voice communications, so automated redaction techniques have been developed to address this problem.

Current automated redaction techniques involve detecting numerical information, which is often of a sensitive nature, and removing the sensitive data from captured voice communications after the fact. Algorithms are then used to replace any identified numerical information by identifying patterns in the data. For example, a date may be replaced by looking for patterns of numbers that resemble a month/day/year format or the like. These techniques are quite limited and often result in more data being removed than is optimal, with valuable non-sensitive data being remove from the captured voice communications as an over precaution. For example, an insurance policy number may resemble a credit card number and be removed via redactions, but be of high value when resolving a customer complaint.

The presently disclosed redaction systems and methods seek to address the above-mentioned limitations of existing automated redaction techniques by using primary and secondary triggers when analyzing voice communications to reduce the rate of false positives when redacting the sensitive information.

### SUMMARY

The presently disclosed redaction systems and methods use a set of triggers to initiate the redaction capabilities. A primary trigger is initiated when sensitive data is first detected and acts forward in time from the detection event. A secondary trigger is initiated at the end or during the timing of the first trigger and acts both backwards and forwards in time from its initiation. Combining the detection results from these two triggers allows confidence that all sensitive data will be removed while avoiding false positives.

### BRIEF DESCRIPTION OF THE DRAWINGS

The accompanying drawings, which are incorporated herein and form part of the specification, illustrate one or more aspects of the present invention and, together with the description, further serve to explain the principles of the invention and to enable a person skilled in the relevant art(s) to make and use the invention.

FIG. 1 depicts a system diagram showing an embodiment of the redaction engine according to an embodiment of the invention.

FIG. 2 depicts sample primary and secondary trigger timing used by the redaction engine.

FIG. 3 depicts a flowchart showing the steps used for redaction by the redaction engine.

### DETAILED DESCRIPTION

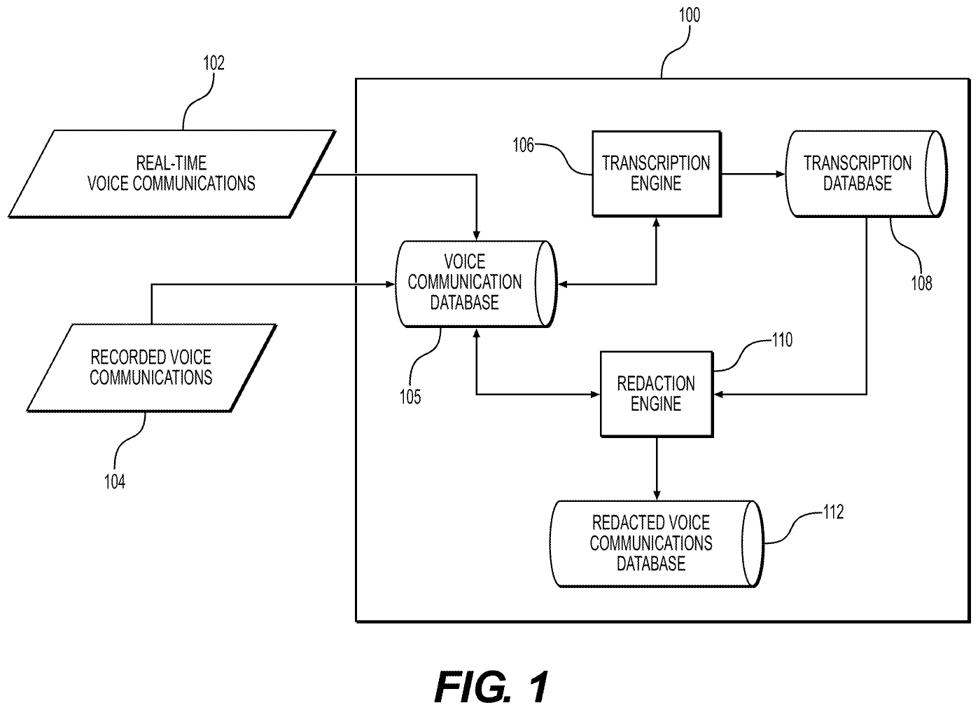

FIG. 1 depicts a system diagram of redaction system 100 showing its primary components. The various functions of redaction system 100 may be executed on a server, a group of servers, or in a distributed cloud computing environment. Real-time voice communications 102 and recorded voice communications 104 are received at redaction system 100 from one or more external sources. Redaction system 100 may be a generalized redaction system programmed to remove multiple types of personally identifiable or sensitive information based on source or may be specific to particular content (e.g., call center or trader floor recordings). The received real-time voice communications and/or recorded voice communications 104 are initially stored in voice communication database 105 for processing. Because there may be personally identifiable or sensitive information contained in the voice communications in voice communication database 105, the voice communications may be encrypted for secure long term storage or purged after the sensitive information has been redacted or obfuscated from the particular voice communication.

For each voice communication received at voice communication database 105, a transcript is generated of the voice recording by transcription engine 106 using known techniques. The transcript may be generated in real-time as the voice communication is received and stored in voice communication database 105 or after the communication is completed via existing natural language processing (NLP) mechanisms.

The transcripts generated by transcription engine 106 are temporarily or permanently stored in transcription database 108 or voice communications database 105. Like any voice communications permanently stored in voice communication database 105, any transcripts stored in transcription database 108 for long term storage are preferably encrypted. Alternatively, transcripts may be purged once they are no longer being used by redaction engine 110 on an as needed basis. The words or phrases in each transcript are associated with timestamps (e.g., beginning and/or end) in the related voice communication.

Redaction engine 110 is responsible for determining which personally identifiable or sensitive information should be redacted from each voice communication. Redaction engine uses a series of primary triggers to detect the start of the personally identifiable or sensitive voice data. The primary triggers can be generated via machine learning (e.g., Binary Classification) or via a pre-generated list using knowledge of voice communications and stored in voice communication database 105. For example, if the voice communications are largely in response to an automated system that requires credit card information, one of the primary triggers may be set in the vicinity of the automated question asking the user for the credit card number. For example, redaction engine 110 may monitor for instances of certain numbers or number combinations used in credit cards as a primary trigger. American Express cards begin with 34 or 37 whereas Visa cards begin with four. Since detection of primary triggers may be delayed due to the processing required, the redaction engine sets an activation of the primary trigger as the first detected element of the primary trigger (e.g., identifying 34 beginning a string of numbers). A primary trigger moves forward in time from the point of activation.

A series of secondary triggers are used to detect an ongoing period of personally identifiable or sensitive data, typically found during or at the end of sensitive data in the voice communications. The secondary triggers can also be generated via machine learning (e.g., Binary Classification) or via a pre-generated list using knowledge of the various types of voice communications being analyzed by redaction system 100. In contrast to the primary triggers, the secondary trigger moves both backwards and forward from the point of activation. Thus, if a primary trigger fails to remove all necessary data, the secondary trigger walks back to ensure any missed sensitive data is still removed. For example, a secondary trigger may involve monitoring for an uninterrupted string of numbers and then checking for the beginning of the string of numbers and the end of the string of numbers. If it is determined that the string of numbers begins with a certain digit and has a predetermined length (e.g., 13-16 digits), the secondary trigger may be flagged for containing sensitive content.

The rules for the primary triggers and the secondary triggers are stored in a trigger database. The trigger database may contain an association of primary triggers to secondary triggers. For example, a primary trigger related to detecting a credit card number may be associated with a secondary trigger related to detecting a string of numbers of a certain length. The association between primary triggers and secondary triggers does not necessarily have to be a 1:1 correspondence. For example, two secondary triggers may be associated with a single primary trigger and vice versa. If it is determined that the speech pattern is fast, a first secondary trigger may be chosen having a first detection time period and if it is determined that the speech pattern is slow, a secondary trigger may be chosen having a second detection time period longer than the first detection time period to account for the difference in speed.

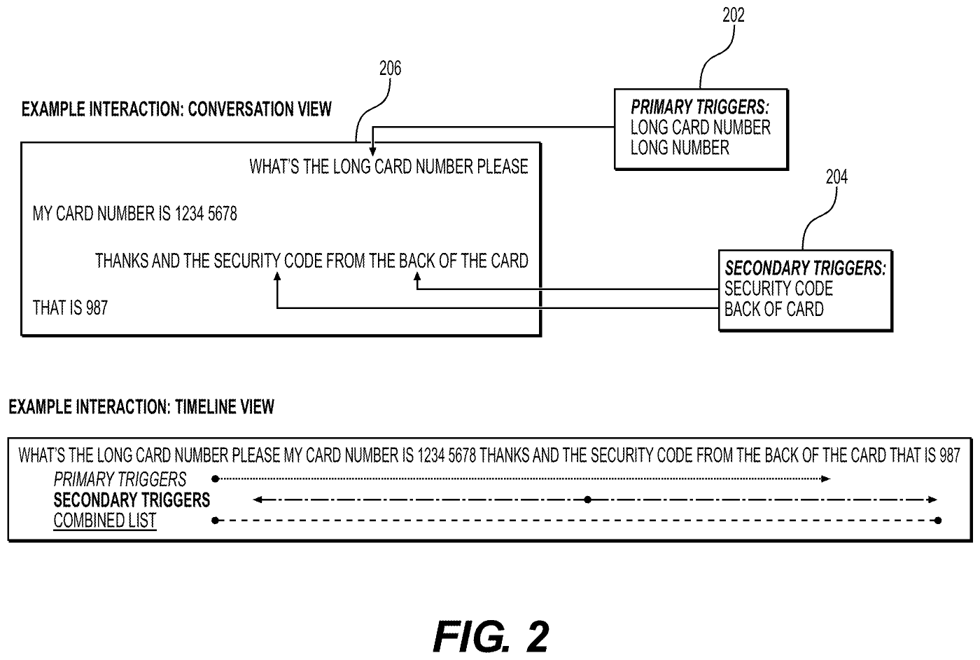

FIG. 2 depicts some examples of primary and secondary triggers for credit card redaction. The triggers can be configured to identify and redact any type of information. The secondary triggers primarily serve as a failsafe in case the primary trigger fails to remove all required data. If the primary trigger has successfully removed all required data, then the secondary trigger won't perform any further redaction. That is, the secondary trigger is only activated if the primary trigger does not result in the identification of information to be redacted in some embodiments. The time periods for the duration of each trigger are configurable. For example, the primary trigger may be set to be the average length of time it takes a person to recite a credit card number. This particular length of time can be determined in advance by analyzing previous voice recordings. A secondary trigger in this circumstance could be set to have a time length that is the same as the primary trigger (both forward and backward) or some percentage of the time of the first trigger.

In some embodiments, the failure of a primary trigger may trigger a plurality of secondary triggers to identify the sensitive content. One secondary trigger may be set to identify a certain number length and another secondary trigger may be set to identify a phrase typically used after the end of certain sensitive content (e.g., an expiration date).

If a primary or secondary trigger identifies certain information, then further policies can be triggered to identify and redact further data. For example, if health policy details are identified, then additional redaction of health conditions could be performed.

For each voice communication, the entire audio is analyzed using the primary triggers and secondary triggers to create two data sets of sensitive information from the transcript. The two data sets are combined to determine an overall set of portions of the communication to be redacted. That is, the results from both the primary triggers and secondary triggers are joined or merged to determine a plurality of start points and end points that may contain sensitive information to be identified. From the overall set, a set of timeslices that contain sensitive data can be identified in the voice communication. The set of timeslices can then be combined with existing methods of blanking, cutting, or obfuscating audio and a redacted voice communication is output by redaction engine. These redacted voice communications can then be stored in redacted voice communications database 112 for later access or use. In some embodiments, the original voice communication records may be replace with redacted records. In some embodiments, the redacted voice communications may further be stored with an encrypted version of the original voice communication in voice communications database 112.

FIG. 2 depicts an example interaction showing example primary triggers and secondary triggers which may be activated during analysis of a voice communication. Primary trigger 202 may comprise detection of the phrase “long card number” or “long number” in the transcript 206. As shown in the timeline view, the detection of a primary trigger 202 initiates a “listening period” for the detection of the expected sensitive information. In this case, the detected information is a credit card number which is flagged by redaction engine 110 as sensitive information. However, as can be seen in the timeline view, the time period for the primary trigger 202 stops before the user has stated their security code.

A secondary trigger 204 associated with the first primary trigger 202 comprises detection of the phrase “security” code or “long number” in the transcript 206. As shown in the timeline view, the secondary trigger 204 initiates an analysis of the text a predetermined period before the secondary trigger 204 and a predetermined period after the secondary trigger 204. In this case, the secondary trigger 204 goes back far enough in time to capture the credit card number and goes forward far enough in time to capture the security code. As previously explained, the secondary trigger 204 essentially serves as a backup to the primary trigger 202 in case the primary trigger 202 misses sensitive information, such as the security code, or if it is not triggered at all for any reason (e.g., garbled or low quality voice communication). The secondary trigger is activated or utilized if the associated primary trigger fails to detect information to be redacted. For example, if the primary trigger 202 identifies eight digits when a credit card number is expected, the secondary trigger would be utilized to ensure the entire credit card number is captured and redacted. The sensitive content flagged by the primary triggers and secondary triggers is combined to produce a combined list as shown in the timeline view and ensures that all the required sensitive content is flagged for redaction without generating false positives as is typically done in prior art redaction techniques.

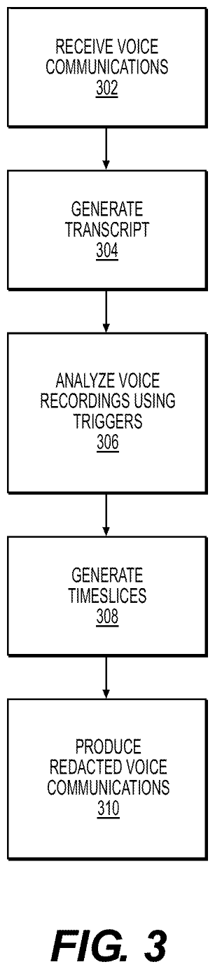

FIG. 3 depicts a flowchart showing the steps carried out by redaction system 100 to produce a redacted voice communication. First, voice communications are received by redaction system 100 in step 102. A transcript is generated for each voice communication in step 304. The voice communication is then analyzed using the primary triggers and secondary triggers contained within redaction engine 110 in step 304. The data sets generated by the primary triggers and secondary triggers are combined to identify all sensitive content in the voice communication and their corresponding timeslices in step 308. The timeslices are used to blank the audio in those sections of the voice communication to produce a redacted voice communication and associated transcript in step 310.

While specific embodiments of the invention have been described above, it will be appreciated that the invention may be practiced other than as described. The embodiment(s) described, and references in the specification to “one embodiment,” “an embodiment,” “an example embodiment,” “some embodiments,” etc., indicate that the embodiment(s) described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is understood that it is within the knowledge of one skilled in the art to effect such feature, structure, or characteristic in connection with other embodiments whether or not explicitly described.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

1. A method of redacting voice communications, comprising:
receiving a recorded voice communication at a redaction system;
analyzing the recorded voice communication using a plurality of primary triggers to identify a first data set of sensitive information and a corresponding first set of time slices;
analyzing the recorded voice communication using a plurality of secondary triggers to identify a second data set of sensitive information and a corresponding second set of time slices;
combining the first set of time slices and the second set of time to determine a combined set of time slices;
redacting any audio data from the recorded voice communication occurring within the combined set of time slices; and
storing the redacted voice communication in a voice communication database of the redaction system.

2. The method according to claim 1, further comprising;
generating a text transcript of the recorded voice communication;
redacting any text in the text transcript corresponding to the audio data from the recorded voice communication occurring within the combined set of time slices; and
storing the text transcript in a transcript database.

3. The method according to claim 1, wherein the text transcript comprises an identifier to identify the redacted voice communication stored in the voice communication database.

4. The method according to claim 1, wherein the redacting comprises blanking, obfuscating, or cutting audio data from the recorded voice communication occurring within the combined set of time slices.

5. The method according to claim 1, wherein at least one secondary trigger of the plurality of secondary triggers is activated only if a corresponding primary trigger of the plurality of primary triggers fails to identify sensitive content.

6. The method according to claim 1, wherein the plurality of secondary triggers are different than the plurality of primary triggers.

7. The method according to claim 1, wherein each primary trigger of the plurality of primary triggers checks for sensitive content by identifying a first detection event and analyzing audio data in the recorded voice communication for a first predetermined time period after the first detection event.

8. The method according to claim 7, wherein audio data occurring before the detection event is not checked for each primary trigger of the plurality of primary triggers.

9. The method according to claim 7, wherein each secondary trigger of the plurality of second triggers checks for sensitive content by identifying a second detection event and analyzing audio data in the recorded voice communication for a second predetermined time period after the second detection event and analyzing audio data in the recorded voice communication for a third predetermined time period before the second detection event.

10. The method according to claim 7, wherein the first detection event is recognition of a start of audio data associated with sensitive content.

11. The method according to claim 10, wherein the first detection event is an identification of a phrase or number combination associated with sensitive content.

12. The method according to claim 11, wherein a time slice associated with the first detection event is set to a beginning of the first detection event.

13. The method according to claim 11, wherein a time slice associated with the detection event is set to an end of the first detection event.

14. The method according to claim 1, further comprising:
encrypting the redacted voice communication prior to storage.

15. The method according to claim 1, further comprising:
storing an encrypted version of the recorded voice communication in the voice communication database in association with the redacted voice communication database.

16. The method according to claim 1, further comprising:
analyzing audio data within the combined set of time slices to identify a third set of time slices comprising non-sensitive data; and
removing the third set of time slices from the combined set of time slices prior to redacting the recorded voice communication.
